(19) United States
(12) Patent Application Publication
(10) Pub. No.: US 2011/0271494 A1
(43) Pub. Date: Nov. 10, 2011

(54) BAND-SECURING DEVICE

(75) Inventors: Alexander Harrison Bellamy, Bothell, WA (US); Richard Radford, Auburn, WA (US)

(73) Assignee: CENORIN, LLC., Kent, WA (US)

(21) Appl. No.: 13/093,644

(22) Filed: Apr. 25, 2011

Related U.S. Application Data
(60) Provisional application No. 61/332,625, filed on May 7, 2010.

(51) Int. Cl. B65D 63/00; F16B 47/00; A44B 11/18

(52) U.S. Cl. 24/16 R; 24/265 BC; 24/304

(57) ABSTRACT

The present disclosure relates generally to mechanisms for securing a band around an object. Certain embodiments relate to band-securing devices. Certain embodiments relate to band-securing devices including a band. Certain embodiments relate to band-securing devices including a band and a medical barrier. Certain embodiments relate to methods of securing a band with a band-securing device. Certain embodiments relate to methods of manufacturing a band-securing device.

### CROSS REFERENCE TO RELATED APPLICATIONS

This application claims priority to U.S. Provisional Patent Application No. 61/332,625, filed May 7, 2010, entitled BAND-SECURING DEVICE, which is hereby incorporated herein by reference in its entirety.

### BACKGROUND OF THE INVENTION

1. Field of the Invention

The present disclosure relates generally to mechanisms for securing a band around an object, such as a flexible medical barrier, as well as associated methods of use and manufacturing.

2. Description of the Related Art

Many types of mechanisms for securing a band exist in the art. However, it is difficult to design a band-securing device that is simple, inexpensive, and convenient to use and manufacture.

### SUMMARY

One embodiment provides a band-securing device comprising a first member having a first opening extending therethrough. The band-securing device further comprises a second member having a second opening extending therethrough. The second member can be formed with or engaged with respect to the first member such that the first and second members can flex or pivot relative to each other. The band-securing device further comprises a first attachment element positioned on the second member distally relative to the second opening. The first attachment element can be configured to be secured to any of multiple locations along a length of a band. The first and second members can be flexed or pivoted relative to each other between a first relative position in which a portion of the first member is spaced from the second member, and a second relative position in which said portion of the first member is substantially adjacent to the second member.

Another embodiment provides a band-securing device comprising a first member having a first opening extending therethrough. The band-securing device further comprises a second member having a second opening extending therethrough. The second member can be formed with or engaged with respect to the first member such that the first and second members can flex or pivot relative to each other. The band-securing device further comprises an attachment element positioned on the second member distally relative to the second opening. The attachment element can be configured to be secured to any of multiple locations along a length of a band. The first and second members can be flexed or pivoted relative to each other between a first relative position in which a portion of the first member is spaced from the second member, and a second relative position in which said portion of the first member is substantially adjacent to the second member. The first and second members can be in the first relative position in a quiescent state of the closure device. The first and second members can be in the second relative position when subjected to a force urging said members together.

Another embodiment provides a band-securing device comprising a first member having a first opening extending therethrough. The band-securing device further comprises a second member having a second opening extending therethrough. The second member can be formed with or engaged with respect to the first member such that the first and second members can flex or pivot relative to each other. The band-securing device further comprises a first attachment element positioned on the second member distally relative to the second opening. The band-securing device further comprises a band comprising a first segment configured to attach to the first attachment element and a second segment connected to another part of the band-securing device. The first and second members can be flexed or pivoted relative to each other between a first relative position in which a portion of the first member is spaced from the second member, and a second relative position in which said portion of the first member is substantially adjacent to the second member.

Another embodiment provides a band-securing device comprising a member having a first opening extending therethrough. The band-securing device further comprises a band extending through the first opening, wherein a portion of the band is secured to a part of the member. The band-securing device further comprises an attachment element positioned on the member distally relative to the first opening. The attachment element is configured to be secured to any of multiple locations along a length of the band. The band-securing device further comprises a handling portion secured to a free end of the band, the handling portion configured to prevent the free end of the band from being pulled through the first opening.

Another embodiment provides a band-securing device comprising a member having a first opening extending therethrough. The band-securing device further comprises an attachment element positioned on the member distally relative to the first opening, the attachment element configured to be secured to any of multiple locations along a length of a band. The band-securing device further comprises a handling portion configured to be secured to a free end of a band, wherein the handling portion is secured to the attachment element.

Another embodiment provides a band-securing device comprising a member. The member comprises a substantially flat portion, the member having a first opening extending through said substantially flat portion. The band-securing device further comprises an attachment element positioned on the member distally relative to the first opening, the attachment element configured to be secured to any of multiple locations along a length of a band. The band-securing device further comprises a guide for a band on the member, the guide positioned distally relative to the attachment element, the guide comprising a second opening extending through the substantially flat portion of the member.

For purposes of summarizing the invention and the advantages achieved over the prior art, certain objects and advantages of the invention have been described above and as further described below. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

The appended drawings are schematic, not necessarily drawn to scale, and are meant to illustrate and not to limit embodiments of the invention.

FIG. 1 shows a bottom and right side perspective view of an embodiment of a band-securing device and a band.

FIG. 2 shows a cross-sectional side view of an embodiment of a band-securing device taken along line 2-2 of FIG. 1.

FIG. 3 shows a cross-sectional side view of another embodiment of a band-securing device, securing a band to an object.

FIGS. 4A and 4B show a side and bottom view, respectively, of an embodiment of a second member of a band-securing device.

FIG. 5 shows a side view of an alternative embodiment of a band-securing device.

FIGS. 6A and 6B each show a top and right side perspective views of an embodiment of an end of a member of a band-securing device.

FIG. 7 shows a top plan view of an embodiment of a band-securing device.

FIGS. 8A and 8B show a front and side view, respectively, of a handling portion that can be used with a band-securing device and a band.

FIG. 9 shows a band-securing device in an exemplary embodiment of use with a band and a medical barrier.

FIG. 10 shows a top and right side perspective view of an embodiment of a band-securing device and a band.

FIG. 11 shows a bottom and left side perspective view of an embodiment of a band-securing device and a band.

FIG. 12 shows a top and left side perspective view of an embodiment of a band-securing device and a band.

FIG. 13 shows a bottom and left side perspective view of an embodiment of a band-securing device and a band.

### DETAILED DESCRIPTION OF THE DRAWINGS

The present disclosure relates generally to mechanisms for securing a band. Certain embodiments relate to band-securing devices. Certain embodiments relate to band-securing devices including a band. Certain embodiments relate to band-securing devices including a band and a medical barrier. Certain embodiments relate to methods of securing a band with a band-securing device. Certain embodiments relate to methods of manufacturing a band-securing device.

Various designs of band-securing devices have been developed to secure a band, strap, or other band-like structure to an object, such as a patient's appendage. Some of these conventional devices have been designed with complex and often expensive structures, such as zippers or other elaborate fastening systems. Other conventional band-securing devices are difficult to apply to, or remove from, a patient's appendage, particularly for a patient with only a single hand available, or for a user with limited physical capacity, such as children, geriatric patients, or those suffering ailments such as arthritis and the like. Simpler designs may not adequately hold a band around an object, or may not allow a band to be repeatably attached and released from the object. Other band-securing devices may not allow bands to be applied under many different tensions around an object, and/or may only allow the device and the band to be used in a single application and then discarded. Other conventional band-securing devices may require two or more hands to secure a band to an object, which can be difficult for a single user, for example, if the object about which the band is being applied happens to be the user's hand or arm.

The disclosed embodiments provide a simple and inexpensive band-securing device that, when used with a band, is easy for the user to apply to and remove from an object, such as a geriatric or arthritic patient. In some embodiments, the device can secure a band to an object using a single hand. It should be understood that the disclosed embodiments present examples of the present inventions for illustrative purposes, and that the scope of the present inventions is not limited to the embodiments disclosed herein.

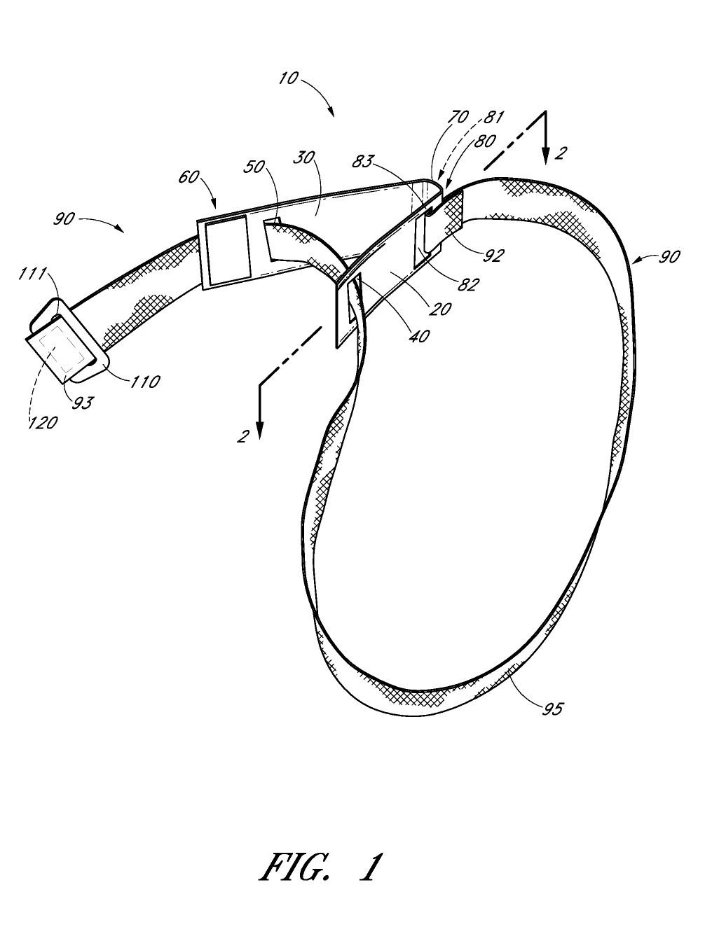

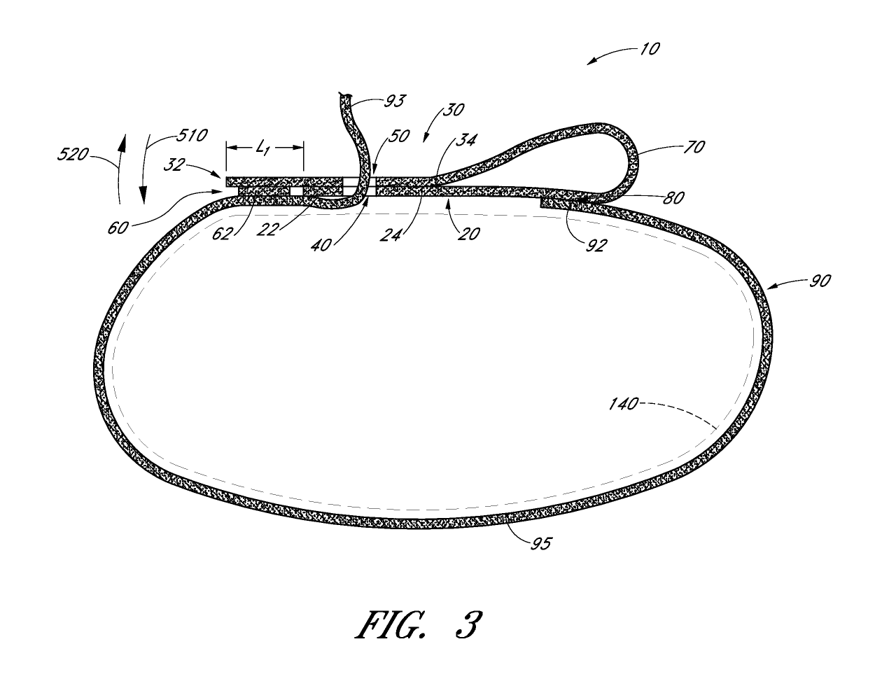

FIG. 1 shows a bottom and right side perspective view of an embodiment of a strap or band-securing mechanism, such as a latch, buckle, clasp, cinch, or the like, illustrated here as a band-securing device 10. Band-securing device 10 is shown in an exemplary environment of use, wherein the device 10 can secure (e.g., releasably secure) a portion of a strap, webbing, band, belt, leash, strip, string, rope, or any other band or strap-like structure, illustrated here as an exemplary band 90. Other exemplary bands or straps that may be used with band-securing device 10 are described in U.S. Provisional Patent Application No. 61/320,886, filed on Apr. 5, 2010, and U.S. Provisional Patent Application No. 61/322,708, filed on Apr. 9, 2010, the entirety of which are herein incorporated by reference. The band-securing device 10 can secure and hold a portion of the band 90 at least partially around one or more objects, preferably, with the band in tension. Even more preferably, the band-securing device 10 can secure and hold a portion of the band 90 stretched and in tension around one or more objects. A first portion of the band 90, illustrated as an attached band portion 92 (e.g., the proximal end of band 90), can be attached to a part of device 10, with a remaining portion of the band 90 routed at least partially around an object (e.g., an object 140; FIG. 3). The band 90 can comprise a second portion 93 (e.g., a free end) extending from, and in some embodiments through, device 10. The second portion of the band 90 preferably can be pulled, to apply tension to, and in some embodiments stretch, band 90, preferably at an end opposing the attached band portion 92. A third portion 95 of the band 90 can extend between the first portion 92 and the second portion 93 of the band and wrap at least partially around an object. In some embodiments, the third portion 95 can comprise a loop that allows device 10 to be used to hold an object inserted into loop 95. It will be understood that although some embodiments described herein include a continuous band 90 routed through the device 10, and with the loop 95 wrapped around an object, the invention is not limited to such embodiments. For example, the band 90 can comprise two or more separate pieces, with two of the pieces attached at one end to band-securing device 10, and attached at the opposing end to a separate structure, such as an object, or some other intermediate structure to be secured around an object (e.g., a medical barrier, or to another of one of the separate band pieces).

An optional handling portion 110, such as a clip, clasp or other structure (FIGS. 1; 8A-8B), can be provided at (e.g., formed integrally with or secured to) the free end 93 of the band 90, to allow a user to easily grasp, pull, and tighten band 90, and to prevent the free end 93 from being pulled back through device 10 while in use. Handling portion 110 can facilitate the use of device 10 and band 90 by a physically challenged user (e.g., an arthritic, geriatric, or other physically-challenged user), and/or allow device 10 to be used more easily with a single hand.

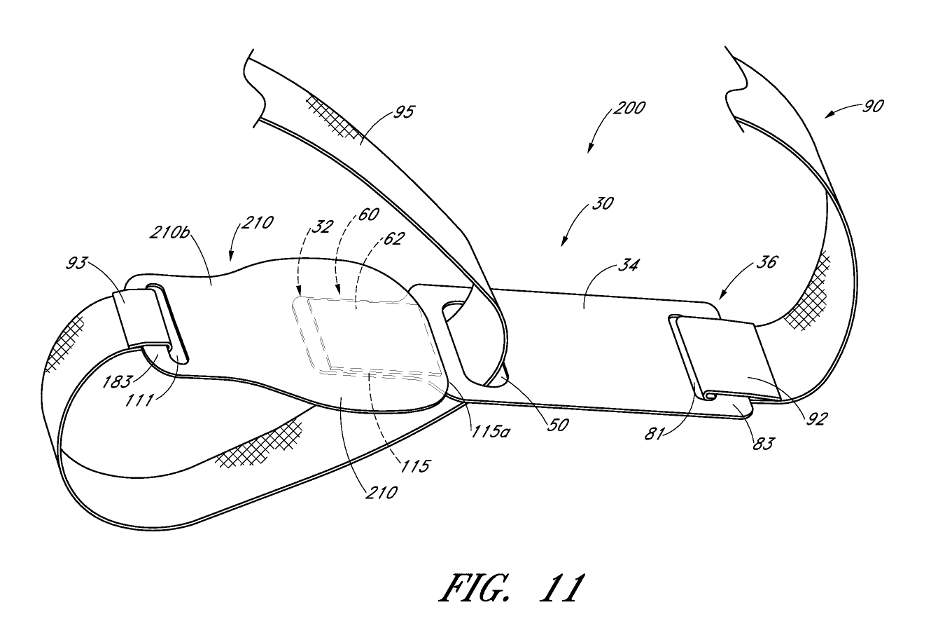

Band-securing device 10 can be used to secure band 90 around any of a variety of different types of objects or plurality of objects, animate or inanimate. In some environments of use, band-securing device 10 can be configured to apply and hold the band 90 around the perimeter or circumference of a user's or patient's appendage, e.g., to form a tourniquet around a patient's arm or leg. As used herein, the term “circumference” does not necessarily imply circularity, unless so indicated. In another environment of use, one or more band-securing devices 10 can be configured to hold an intermediate structure, e.g., a medical barrier 150 (FIG. 9), between the band 90 and the patient's appendage, such as medical barrier embodiments described in U.S. Provisional Patent Application Nos. 61/320,886 and 61/322,708. It will be understood that “patient,” as used herein, is not limited to humans or any particular species of animal, and the embodiments of the band-securing device 10 described herein can be used on non-human animals.

It will also be understood that although many of the embodiments herein describe the use of band-securing device 10 in conjunction with the band 90, and in some embodiments, a medical barrier, the band-securing device 10 can be manufactured and provided independently without a band or medical barrier. Thus, the invention does not require the band or medical barrier to be provided with the band-securing device. In some embodiments, the band-securing device 10 can be provided to a user without a band 90 and/or without a medical barrier, and the user can provide a separate band and/or medical barrier to be used with the device 10. Any combination of the band-securing device 10, the band 90, and/or the medical barrier can also be supplied as a kit, wherein the band-securing device 10, the band 90, and/or the medical barrier can be supplied separately and then assembled by the user.

The exemplary band 90 can comprise any of many flexible, and in some embodiments, stretchable or elastic material known in the art, with sufficient strength to hold an object under a desired tension. The band 90 can comprise any of many different types of films, membranes, or substrates. The band 90 may be any of myriad compositions suitable for short-term or long-term contact with a user's skin. The band 90 can comprise a waterproof, water-resistant, or hydrophilic material. In some embodiments, any portion of the band 90 can be coated, for example, with pharmaceutical or other therapeutical treatments to improve the comfort and health of the user. The band 90 may comprise one or more layers of material, and may comprise one or more materials along its length or width. The band 90 may alternatively or additionally be comprised of polymers, plastics, and water-vapor-breathable films, layers, and materials. The band 90 may be any color, clear or opaque to any degree, and may be printed, for example, with brand or source identification, constructions or application, aesthetic decorations, and the like. The band 90 can comprise various materials known to the industry that can provide adequate elasticity to compress against a user's appendage when the band 90 is in tension around such appendage, such as natural or synthetic rubber materials (e.g. polyisoprene). In a preferred embodiment, band 90 comprises polyurethane. In some embodiments, band 90 can comprise one or more attachment elements positioned along its length, and configured to attach to a portion of device 10, or in some embodiments, a mating attachment element positioned on a portion of device 10.

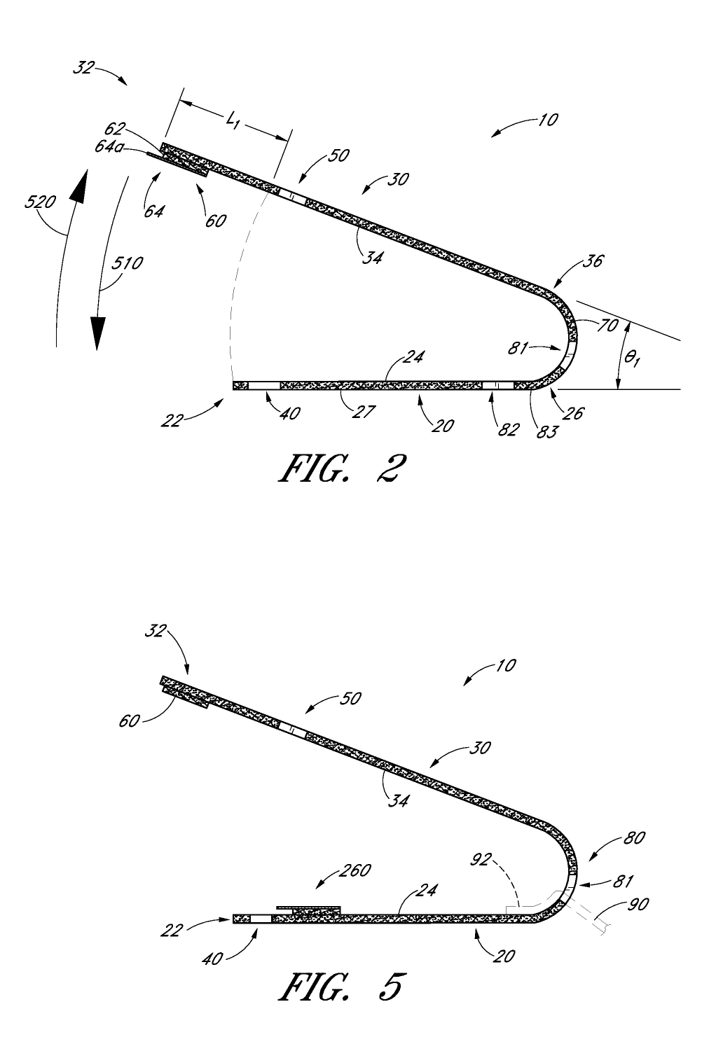

FIG. 2 shows a cross-sectional side view of an embodiment of the band-securing device 10 taken along line 2-2 of FIG. 1. Referring to FIGS. 1 and 2, the band-securing device 10 can comprise a first member 20 formed with or engaged with respect to a second member 30 such that the first member 20 and second member 30 can flex or pivot relative to each other. In some embodiments, first member 20 and second member 30 can be substantially linear and oriented at an angle θ₁ relative to each other when the members 20 and 30 are in a quiescent state.

The various embodiments of first and second members 20, 30 described herein can comprise any of many different materials, such as plastic or metal, and can comprise more than one material, such as a composite, alloy, or a metal coated with rubber, plastic, or foam, or different materials spanning a portion of the length and/or width of members 20 and/or 30. The members 20, 30 can comprise the same or can comprise different materials relative to each other. The members 20, 30 can be thermally, chemically or mechanically treated to provide, or can comprise any material that provides, increased durability, flexibility, moisture absorption or adsorption, and/or chemical resistance. The members 20, 30 can comprise a material of any color, and can comprise a substantially transparent, opaque, or translucent material, or any combination thereof. The members 20, 30 may be any of myriad compositions suitable for short-term or long-term contact with a user's skin. The members 20, 30 can be constructed of a relatively flexible yet at least partially elastic material, which can deform to facilitate application and/or to improve fit around an object, and in some embodiments return to (or at least partially towards) the original shape when removed from the object. In some embodiments, member 20, 30 can comprise a permanently deformable material or materials. One exemplary material for member 20 and/or 30 comprises urethane, though other polymeric materials are known which can satisfy these needs. In a preferred embodiment, members 20 and/or 30 comprise polycarbonate.

The various cross sections of first member 20 can comprise any of many different shapes, such as an approximately rectangular, elliptical, trapezoidal, or any other regular or irregular shape that can be formed with or engage with second member 30. First member 20 can comprise any shape that allows first member 20 to flex or pivot relative to second member 30. In some embodiments, member 20 comprises any shape that conforms to or allows first member 20 to flex and/or conform to an object about which band 90 (FIG. 1) is at least partially wrapped. First member 20 is shown with approximately straight and parallel sides, and approximately flat surfaces, for illustrative purposes only; it will be understood that first member 20 can comprise substantially non-parallel and/or curved sides, and can comprise a surface with any of many contoured shapes. In a preferred embodiment, first member 20 comprises an oblong or elongated shape along one or more of its longitudinal cross-sections. Even more preferably, first member 20 comprises an approximately three-dimensional rectangular prism-shaped member.

First member 20 can comprise an opening 40 extending therethrough. Opening 40 can have many different shapes and sizes, such as an opening or slot that spans some, most, or all of the width of first member 20. Opening 40 can be sized and shaped to allow a portion of band 90 (e.g., free end 93) to extend or be extended through first member 20. Opening 40 can comprise tapered (e.g., curved or angled) edges or sidewalls, or stepped or radiused shoulders, to guide a portion of band 90 into or through opening 40, or to reduce friction and snagging between band 90 and opening 40. Opening 40 can be curved or oriented at many angles relative to first member 20 to guide, or change the direction of the band routing through first member 20. Opening 40 can be curved or oriented at an angle, to advance a portion of a band either distally or proximally as a portion of the band is extended through member 20. Thus opening 40 need not be straight, and need not be orthogonal relative to the surface of member 20. Opening 40 can be positioned anywhere along the length and/or width of first member 20, and preferably is positioned proximate to a distal end 22 of first member 20. In some embodiments, opening 40 can be substantially aligned with an opening 50 in second member 30, when first member 20 and second member 30 are substantially adjacent to each other, as described further herein (FIG. 3). Providing such substantial alignment between openings 40 and 50 can allow band 90 to more easily extend through these openings when device 10 is used to tighten band 90 around a portion of an object. In this manner device 10 and band 90 can be more easily used by a physically challenged user (e.g., an arthritic, geriatric, or other physically-challenged user), and/or can be used more easily with a single hand.

Second member 30 can have similar structure and can function substantially similarly to first member 20. Second member 30 can comprise any of the shapes described herein for first member 20, and can comprise approximately the same or different shape as first member 20. In a preferred embodiment, second member 30 comprises an oblong or elongated shape along its longitudinal cross-section. Even more preferably, second member 30 comprises an approximately three-dimensional rectangular prism-shaped member. Second member 30 can comprise approximately the same or different length and/or width as first member 20. In some embodiments, second member 30 can comprise a distal end 32 that extends distally by a length L₁ relative to distal end 22 of first member 20, when first member 20 is positioned approximately adjacent to second member 30 (FIG. 3). In some embodiments, second member 30 can comprise a distal end that is approximately aligned with the distal end of first member 20, when first member 20 is positioned approximately adjacent to second member 30.

The length L₁ can be selected to facilitate the securement of an attachment element positioned on member 30 to a portion of band 90, as described further herein. L₁ can be defined as a multiple of the overall length of member 20, such as 1X, 2X, 3X, 4X, etc of the overall length of member 20. In some embodiments, L₁ can be defined as a percentage of the overall length of member 20. In some embodiments, L₁ can range from approximately 1 to 100% of the overall length of member 20, or more narrowly, approximately 5 to 80%, or more narrowly, approximately 10 to 70%, or even more narrowly, approximately 15 to 60% of the overall length of member 20.

Second member 30 can comprise an opening 50 extending therethrough. Opening 50 can be similar to and function substantially similarly to opening 40 (e.g., size, shape, positioning, orientation, etc.). In some embodiments, opening 50 can be substantially aligned with opening 40, when first member 20 and second member 30 are positioned substantially adjacent to each other, as described further herein. Opening 50 can be positioned anywhere along the length and/or width of second member 30, and can be positioned proximate to the distal end 32 of second member 30. In some embodiments, opening 50 can be positioned relative to one or more attachment elements that can be configured to attach a portion of second member 30 to a portion of band 90 and/or first member 20, as described herein.

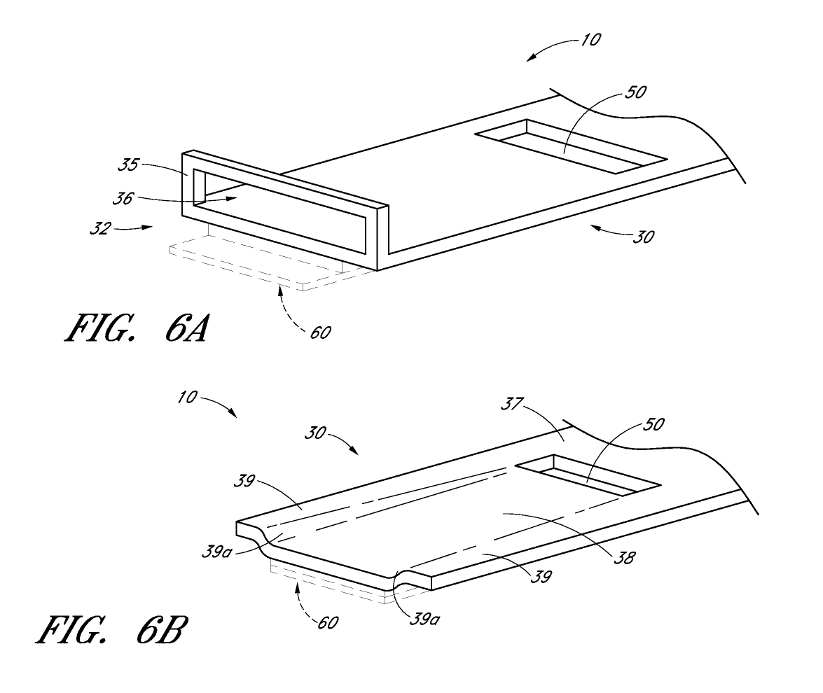

Device 10 can comprise one or more attachment elements configured to attach a portion (e.g., a proximal end portion) of band 90 to a part of device 10 (e.g., first member 20 and/or second member 30; FIG. 3), and/or to attach a part of device 10 to another part of device 10 (e.g., to attach first member 20 to second member 30; FIG. 5), and/or to attach part of device 10 to an external object (e.g., to attach first member 20 and/or second member 30 to a medical barrier 150; FIG. 9). The attachment elements can be positioned in any of many different locations along the length and/or width of device 10 and its components, and can span some, most, or all of the length and/or width of device 10. The attachment elements, or a portion thereof, can extend distally, proximally, or laterally relative to device 10 and its various components. The embodiments of the attachment elements described herein are for illustrative, exemplary purposes, and can comprise any of many different known fastener elements for attaching two objects, such as adhesive (e.g., pressure sensitive), clasps, snaps, zippers, buttons, hook/loop (e.g., Velcro™), stitching, and the like.

Referring to FIG. 2, device 10 can comprise one or more attachment elements 60 positioned on second member 30. Attachment element 60 can be similar to and function substantially similarly to the other embodiments of attachment elements described herein. In the exemplary embodiment, attachment element 60 can comprise an adhesive layer 62, the adhesive layer attached on one side to a portion of member 20 and covered on an opposing side by a release liner or release layer 64. In use, the release layer 64 can be removed from adhesive layer 62, to expose adhesive layer 62 and facilitate its attachment to another surface (e.g., a portion of band 90 and/or first member 20).

Attachment element 60 can be positioned anywhere along second member 30 that facilitates the securement of attachment element 60 to any of multiple locations along a length of band 90. Attachment element 60 can attach directly to member 30, or can be attached to an intermediate structure attached to member 30. Attachment element 60 can be configured to be secured directly to band 90, or can be configured to be secured to an intermediate structure (e.g., a mating attachment element) attached to band 90. Attachment element 60 can span some, most, or all of the length and/or width of second member 30, in a spaced or continuous configuration. Attachment element 60 can be positioned proximate to, and preferably is attached near to or connected near to, the distal end 32 of member 30. In some embodiments, attachment element 60 can extend distally from the distal end 32 of second member 30. In some embodiments, attachment element 60 can be positioned distally relative to the second opening 50. In a preferred embodiment, attachment element 60 is positioned on member 30 such that the attachment element 60 extends distally relative to the distal end 22 of the first member 20 when the first and second members 20, 30, are positioned substantially adjacent to each other (FIG. 3). In some embodiments, element 60 can extend laterally beyond one or both of the side edges of the width of the second member 30. In some embodiments, element 60 can be positioned on an inner side 34 of second member 30 that is opposed to (e.g. faces) an inner side 24 of first member 20.

The adhesive layer 62 and release layer 64 can comprise any of many materials and configurations known in the art, such as those disclosed in U.S. Provisional Patent Application No. 61/320,886. The adhesive layer 62 may comprise, for example, without limitation, pressure-sensitive, thermo-sensitive, and/or radiation-sensitive adhesive materials. The adhesive layer 62 can comprise single or double-sided tape, such as medical tape. The adhesive layer 62 can comprise non-toxic adhesives, adhesives that allow waterproof adhesion, and/or adhesives that facilitate comfortable attachment to and removal from contact with a patient's body. The adhesive layer 62 can comprise a continuous layer of adhesive, or in some embodiments, a plurality of intermittent or selectively located adhesive regions. In addition to the various compositions possible within the examples described elsewhere in the present disclosure, the adhesive used within the adhesive layer portions described herein can be disposed using a variety of methods in a variety of fashions and in a variety of configurations or patterns. Some embodiments may optimize the contact and adhesive properties of the band 90. The adhesive layer 62 can be applied in a single or variety of patterns, such as adhesive disposed along a straight line path, in a circular pattern, dot pattern, or a zigzag pattern on a portion of the medical barrier. In other embodiments, the adhesive layer is disposed randomly. The adhesive strength and the configuration of adhesive layer 62 can be selected to adequately secure and hold part of device 10 (e.g., member 30) to another surface (e.g., a portion of band 90), while still allowing a user to detach the part of device 10 from the other surface.

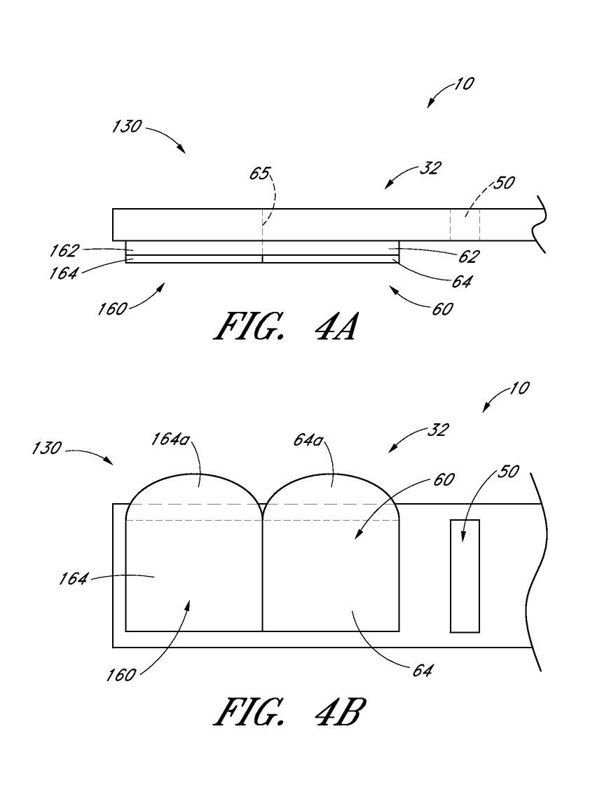

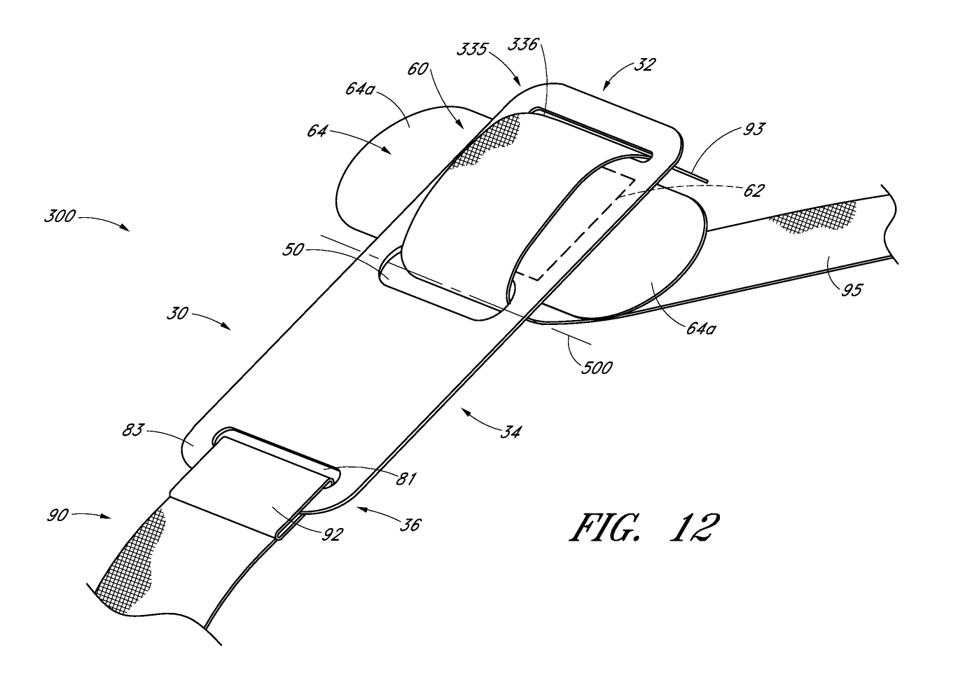

The release layer 64 can comprise a protective film or membrane comprising and/or coated with one or more materials with properties (e.g., coefficient of friction, surface tension, surface smoothness and/or roughness, and the like) to allow release layer 64 to be peelable or removable from adhesive layer 62, without peeling or removing layer 62 from member 30. Such materials or coatings are well known in the art, and may comprise silicone, PVC, polytetrafluoroethylene (PTFE), polyethylene (PET), polypropylene, and the like. In a preferred embodiment, release layer 64 comprises a PET membrane with a silicone release coating on one or more sides. Release layer 64 can comprise one or more handling portions (e.g., a tab or tabs) extending distally and/or laterally relative to a portion of adhesive layer 62 and/or member 20 and/or member 30 to facilitate the removal of release layer 64 from adhesive layer 62. In the illustrative embodiment, release layer 64 is shown with a handling portion 64a extending distally relative to adhesive layer 62 and member 30. FIG. 4B shows an exemplary embodiment of a handling portion 64a that extends laterally relative to the underlying adhesive and member 30. In some embodiments, handling portion 64a can extend laterally from both sides of member 30 (FIGS. 10 and 11). Handling portion 64a can allow a user to easily grasp and remove release layer 64 to expose adhesive layer 62. Thus, handling portion 64a can facilitate the use of device 10 and band 90 by a physically challenged user (e.g., an arthritic, geriatric or other physically-challenged user), and/or allow device 10 to be used more easily with a single hand.

The size of handling portion 64a (i.e., the distance handling portion 64a extends from a lateral or distal edge of member 30 and/or a lateral or distal edge of adhesive 62) can be selected to provide sufficient area for a user (e.g., a physically challenged user) to grasp portion 64a. In some embodiments, the size of handling portion 64a can range from approximately 0.1 to 4 inches, or more narrowly, 0.2 to 2 inches, or even more narrowly, 0.25 to 1.5 inches, or even more narrowly, from 0.35 to 1.0 inches. The size of handling portion 64a can be selected to be a multiple of the overall width of member 30 and/or adhesive 62, e.g., 1X, 2X, 3X, etc. The size of handling portion 64a can be selected to be a percentage of the overall width of member 30 and/or adhesive 62. In some embodiments, the size of handling portion 64a can range from 1 to 100%, or more narrowly, approximately 5 to 80%, or more narrowly, approximately 10 to 70%, or even more narrowly, approximately 15 to 60% of the overall width of member 30 and/or adhesive 62.

FIG. 3 shows a cross-sectional side view of an embodiment of the band-securing device 10 of FIG. 2. Referring to FIGS. 1-3, and as described further herein, first member 20 can be formed integrally with or engaged with respect to second member 30 such that first member 20 and second member 30 can flex or pivot relative to each other. First member 20 can be formed with or engaged with respect to second member 30 in any of many different ways.

Members 20, 30 can be integrally or separately formed using any of many known construction techniques, including injection molding, casting, machining, thermoforming, and the like. In some embodiments, members 20, 30 can be integrally or separately formed by pressing, stamping, embossing, die cutting or punching the approximate shape of members 20, 30 from a sheet. When members 20, 30 are integrally formed, a subsequent step (e.g., a bending step that mechanically or thermally stresses the partially formed device 10) can be used to position members 20, 30 at a desired orientation relative to each other (e.g., at angle θ₁). When members 20, 30 are separately formed, a subsequent step can be used to attach and position members 20, 30 relative to each other (e.g., welding, adhesives, bonding (ultrasonic, chemical, thermal, etc.), and other known attachment techniques).

Members 20, 30 can be connected to each other in many different ways, and at many different positions along the length and/or width of the other of members 20, 30, to allow members 20, 30 to flex relative to each other. In the illustrated embodiment, members 20, 30 are shown connected to each other at their respective proximal ends 26, 36. In some embodiments, members 20, 30 are connected in a manner that forms a smooth curved portion 70 (e.g., an outwardly-facing convex portion) that provides a smooth transition between the proximal ends 26, 36 at the proximal end of device 10. It will be understood that the proximal end 26 of member 20 can be connected to member 30 at a position between the proximal and distal ends 36, 32 of member 30, and vice versa. It will also be understood that members 20, 30 can be connected to each other without the curved portion 70 therebetween, or with one or more alternatively configured curved and/or straight members therebetween.

Members 20, 30 can be connected directly to each other, as shown, or can be connected to an intermediate structure that is connected to each of members 20, 30. In some embodiments, members 20, 30 can comprise or can be connected to any of many structures known in the art to permit rotational movement between members 20, 30. Such structures (e.g., rotational members) can comprise one or more hubs, bearings, hinges, pins, balls and sockets, axles, rotational joints, clutches, discs, and the like. As such, members 20, 30 can be configured to be engaged with respect to each other so that members 20, 30 can pivot relative to each other. Various rotational members employed within a strap closure device are described in U.S. Provisional Patent Application No. 61/322,708.

Referring to FIG. 2, members 20, 30 can be positioned relative to each other such that the distal end 22 is spaced from member 30 (e.g., “Position 1”). In some embodiments, distal end 22 can be spaced from member 30 when member 30 is flexed or pivoted relative to member 20 in a direction shown by arrow 520. Preferably, distal end 22 is spaced from member 30 when members 20, 30 are in a quiescent (e.g., unflexed) state. Distal end 22 can be spaced from member 30 when members 20, 30 are positioned relative to each other at angle θ₁.

Angle θ₁ can be selected to facilitate a user in grasping and removing release layer 64 during the application of device 10 (FIGS. 1, 3, 9). Angle θ₁ can also be selected to prevent attachment element 60 (or a portion thereof, e.g., adhesive layer 62, when exposed) from inadvertently attaching to an undesired surface (e.g., a portion of device 10, band 90, etc.), during application of device 10. Angle θ₁ can also be selected to facilitate the insertion, extension, and movement of a portion of band 90 through openings 40, 50 during the tightening of band 90 around an object. Thus, the orientation of members 20, 30 and the selection of angle θ₁ can facilitate the use of device 10 and band 90 by a physically challenged user (e.g., an arthritic, geriatric or other physically-challenged user), and/or allow device 10 to be used more easily with a single hand. In some embodiments, angle θ₁ can range from approximately 1 to 180 degrees, or more narrowly, from approximately 3 to 90 degrees, or even more narrowly, from approximately 5 to 75 degrees, or even more narrowly, from approximately 10 to 65 degrees.

Referring to FIG. 3, members 20, 30 can be positioned relative to each other such that the distal end 22 of member 20 is substantially adjacent to a portion of the second member 30 (e.g., “Position 2”). Distal end 22 can be substantially adjacent to second member 30 when member 30 is flexed or pivoted relative to member 20 in a direction shown by arrow 510. Preferably, distal end 22 is substantially adjacent to a portion of member 30 when members 20, 30 are flexed toward one another. Distal end 22 can be substantially adjacent to a portion of member 30 when angle θ₁ is approximately zero degrees. Distal end 22 can be substantially adjacent to a portion of member 30 when a portion of the inner side 34 of second member 30 is substantially adjacent to, or preferably, in contact with, a portion of the inner side 24 of first member 20. In some embodiments, when device 10 is in Position 2, at least a portion of attachment element 60 can extend distally relative to the distal end 22 of first member 20. This allows element 60 (e.g., exposed adhesive layer 62) to be secured to a portion of band 90 (e.g., a portion of loop 95), as described further herein.

FIGS. 4A, 4B and 5 show embodiments of device 10 with various embodiments of attachment elements. FIGS. 4A and 4B show a side and bottom view, respectively, of an embodiment of a second member 130 of a device 10. Second member 130 can be similar to and function substantially similarly to member 30 (FIGS. 1-3). One difference is that member 130 can comprise one or more additional attachment elements positioned on member 130, illustrated here as a second attachment element 160 positioned distally on member 130 relative to attachment element 60. Attachment elements 60 and 160 are shown, for illustrative purposes only, with release layers 64, 164, including handling portions 64a, 164a extending laterally from adhesive layers 62, 162, respectively, and member 130. Attachment element 160 can be similar to and function substantially similarly to attachment element 60, although it will be understood that element 160 can comprise the same or different properties as element 60 (e.g., size, shape, adhesive strength, etc.).

Positioning an additional attachment element on member 130 can allow a user to attach device 10 (e.g., member 130) to surfaces (e.g., a portion of a band) with varying levels of adhesion. In some embodiments, a user may remove both release liners 64 and 164, and simultaneously apply both attachment elements 60, 160 to a portion of the band. Such embodiments allow band 90 to be secured under higher tension than applying just one of elements 60 or 160. In some embodiments, elements 60, 160 may have different shapes and/or adhering strengths, and a user may select one or the other, or both, when securing device 10, depending on the tension desired in band 90 or application of use. A user may also use elements 60, 160 separately for different uses of the device 10. In such an embodiment, either release layer 64 or release layer 164 can be removed, exposing either adhesive layer 62 or adhesive layer 162, and member 130 can be secured to another surface (e.g., band 90). Member 130 can subsequently be removed from the surface by peeling or otherwise releasing the adhesive layer 62 or 162 from the surface (e.g., if the user wants to check on a wound, or wants to loosen or tighten the band, etc.). Next, the other of elements 60, 160, or both of elements 60, 160 can be used to again secure member 130 to the same or different surface. In this way, elements 60, 160 can allow a user to: (1) secure the device 10 and accompanying band 90 to an object 140, (2) remove the device 10 and band 90 from the object 140, or merely loosen the band 90, and (3) re-secure the device 10 and band 90 to the same object 140 or another object. For example, the user may initially use the attachment element 60 to secure the band 90 and device 10, by securing element 60 to the band 90 with the loop 95 tightly encircling an object 140. Subsequently, the user can change the tension in loop 95 by separating attachment element 60 from the band 90, varying the loop 95 tension, and then either reattaching element 60 to the band, and/or attaching attachment element 162 to the band 90. This embodiment may be beneficial if the first of elements 60, 160 that is attached to band 90 becomes contaminated and loses its adhesive strength during the removal step described above. In some embodiments, attachment element 160 can extend distally, and attachment element 60 can extend proximally, relative to the distal end 22 of first member 20, when the first member 20 and second member 30 are in Position 2. Such embodiments allow element 60 to be attached to a portion of member 20, and element 160 to be secured to a portion of band 90.

With continued reference to FIGS. 4A and 4B, in some embodiments, device 10 can comprise a division 65 (illustrated as a straight line) extending at least partially across the width of member 130 and across the width of attachment elements 60 and/or 160, and between the attachment elements 60 and 160. Division 65 allows the attachment element 160 to be removed from the remainder of member 130 by tearing along the division 65. Division 65 can be formed in any of many different ways known in the art. In a preferred embodiment, division 65 is a perforation line comprising a plurality of aligned perforations extending at least partially across the width of and at least partially through the thickness of member 30 and/or attachment elements 60, 160. In other embodiments, division 65 can be a heavy crease or a strip of releasable adhesive that bonds a portion of element 60 to element 160.

FIG. 5 shows a side view of an embodiment of a device 10 comprising an embodiment of an attachment element 260. As described herein, in some embodiments members 20, 30 are in a flexed state when device 10 is secured to band 90 with attachment element 60. In such embodiments, a balance must be struck between the flexural bias between members 20, 30 (i.e., the force with which members 20 and 30 resist flexing toward one another when flexed toward when another) and the strength of adherence (e.g., adhesive strength, strength of hook/loop connection, etc.) between element 60 and the surface to which it is secured (e.g., a portion of band 90). For example, if the bias between members 20, 30 is too high, element 60 may not adhere to band 90, or may tear band 90 or whatever item to which element 60 is attached. If the bias is too low, distal end 22 may not remain spaced from member 30 when device 10 is being applied, causing element 60 to inadvertently and undesirably be secured to a surface, as described further herein. The configuration (e.g., size, shape, material properties, etc.) of members 20, 30, and element 60 can be varied to strike this balance between the strength of adherence between element 60 and the surface to which it secures, and the bias between members 20, 30. In some embodiments, one or more attachment elements can be configured to secure a portion of members 20, 30 to each other, reducing the amount of adherence required between element 60 and the band 90. In some embodiments, attachment element 60 can comprise a portion that extends proximally relative to the distal end 22 of member 20, when the distal end 22 of member 20 is substantially adjacent to a portion of the second member 30 (e.g., “Position 2”). In such embodiments, a portion of attachment element 60 can secure a portion of first member 20 to a portion of second member 30.

In the exemplary embodiment of FIG. 5, attachment element 260 can be similar to and function substantially similarly to attachment elements 60 and 160, although it will be understood that element 260 can comprise the same or different properties as elements 60, 160 (e.g., size, shape, adhesive strength, etc.). One difference is that attachment element 260 is positioned to secure a portion of member 20 to a portion of member 30, for the reasons described above, or for other reasons. Element 260 is shown attached to member 20, proximally of opening 40, for illustrative purposes only, and can be positioned anywhere along the length and/or width of member 20 and/or 30 that allows a portion of member 20 to be secured to a portion of member 30. Also, some embodiments include a plurality of such attachment elements 260.

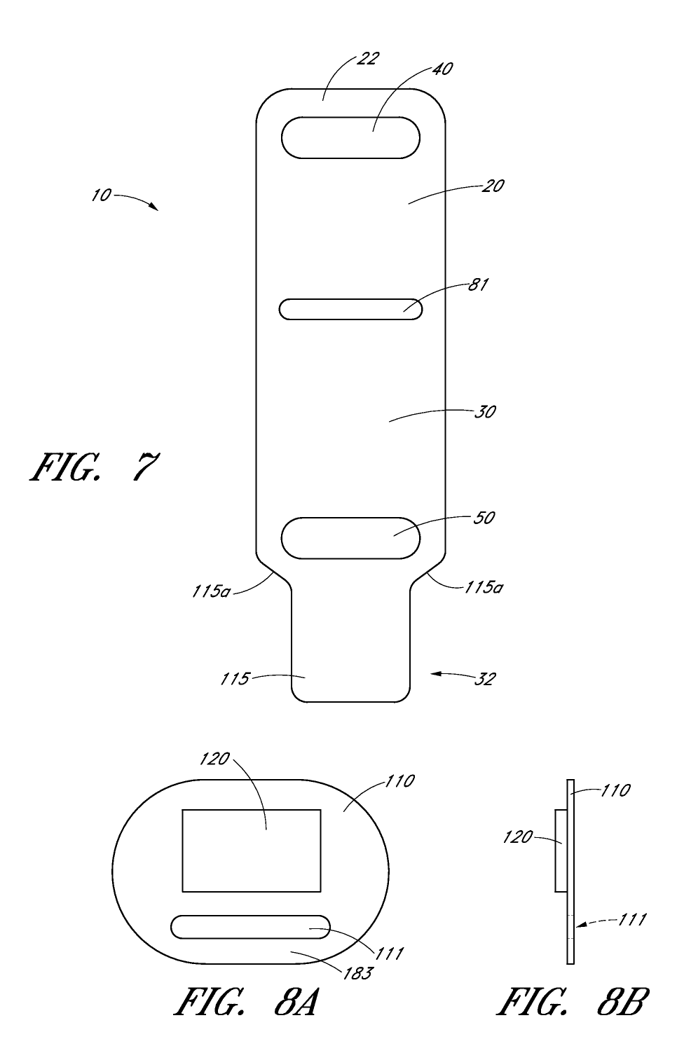

FIGS. 6A and 6B each show a top and right side perspective view of an exemplary embodiment of a distal end of a second member 30 of the band-securing device 10. Device 10 can comprise one or more guides configured to guide a portion of a band relative to members 20 and/or 30. Such guides may prevent the end of the band 90 from folding or tangling, and may guide the band through openings 40 and/or 50, and to and from device 10.

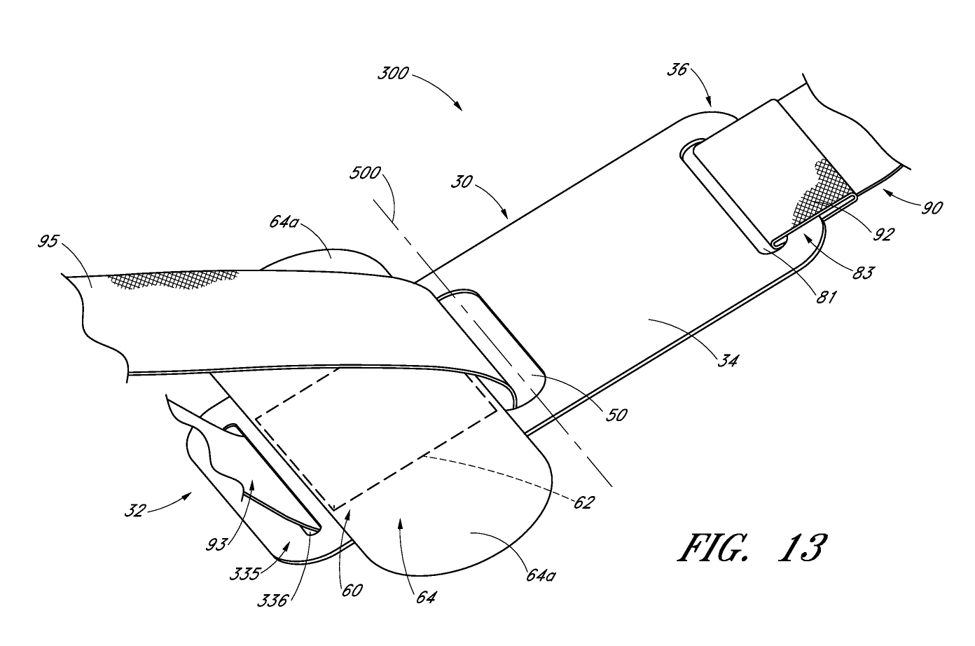

Referring to FIG. 6A, member 30 can comprise a guide portion 35 with a guide 36 extending therethrough. In some embodiments, the guide portion 35 and guide 36 can be positioned proximate to the distal end 32 of member 30. In some embodiments, a portion of a band can extend through opening 50 and guide 36, allowing guide 36 to guide a portion of a band from opening 50 towards the distal end 32 of member 30, and away from device 10. Guide 36 may improve the ease with which a user may operate device 10, e.g., while moving member 20 relative to member 30. In some embodiments, guide 36 may facilitate a user's positioning (e.g., alignment) of attachment element 60 relative to an other item (e.g., first member 20 and/or second member 30 and/or a portion of band 90 and/or a medical barrier 150; FIG. 9). Guide 36 may allow a user to move member 20 and/or 30 to facilitate removal and/or attachment, and/or prevent inadvertent attachment, of attachment element 60 (or a portion thereof, e.g., adhesive layer 62, when exposed) to and/or from a surface (e.g., a portion of device 10, band 90, barrier 150; FIG. 9, etc.), during application or removal of device 10. Guide 36 can allow a user to move or flex a portion of member 20 and/or 30 about an axis, as described further herein (FIGS. 12 and 13). Guide 36 can allow a user to move member 20 and/or 30, and/or position attachment element 60 with a single hand, while grasping a portion of band 90, and without grasping a portion of device 10. In some embodiments, guide portion 35 and/or guide 36 can allow a user to move member 20 relative to member 30, by pulling on a portion of band 90. In a preferred embodiment, guide portion 35 and/or guide 36 can allow a user to move member 20 relative to member 30 (e.g., to secure or unsecure member 30 with respect to a surface, e.g., band 90) by grasping a portion of band 90 with a single hand. In a further preferred embodiment, guide portion 35 and/or guide 36 can allow a user to move member 20 relative to member 30 (e.g., secure or unsecure device 10) by grasping a portion of band 90 with a single hand, and without grasping a portion of device 10.

Guide portion 35 and guide 36 can be oriented at various angles relative to each other, and relative to the remainder of member 30. In some embodiments, guide 36 can comprise an opening (e.g. a slot) extending through a portion of member 20 and/or 30, the opening configured such that a portion of band 90 can extend through guide 36. In such embodiments, guide 36 can be substantially similar to and function substantially similar to opening 40 and/or 50, unless stated otherwise herein. In some embodiments, guide 36 can comprise an opening extending through member 20 and/or 30 approximately orthogonally relative to the surface of member 20 and/or 30 (e.g., FIGS. 12-13). In the exemplary illustrated embodiment, guide portion 35 extends approximately orthogonal to member 30, and guide 36 comprises a slot with interior surfaces that extend approximately parallel to the surface of member 30. It will be understood that although guide 36 is shown as an opening, slot, or channel that may surround a band extending therethrough, guide 36 can comprise a structure that guides a band without enclosing or surrounding the band. Other embodiments of band guides incorporated into a mechanism for securing a band are described in U.S. Provisional Patent Application No. 61/322,708.

Referring to FIG. 6B, member 30 can comprise one or more stepped or recessed portions, to guide a portion of a band extending along a surface, e.g. a surface of upper side 37 of member 30. In the illustrated embodiment, a recessed portion 38 of upper side 37 can extend laterally between a paired of opposed outer guide portions 39 positioned along a portion of the opposed edges of member 30, and raised relative to recessed portion 38. Guide portions 39 can be tapered and/or radiused relative to recessed portion 38 and/or along the length of member 30 towards opening 50. Referring to FIGS. 6A and 6B, it will be understood that guide portion 35, guide 36, recessed portion 38, and/or guide portions 39 can be employed in a substantially similar manner to first member 20 and opening 40.

Referring again to FIGS. 1-3 and 5, device 10 can be configured to be attached to a portion of band 90 (e.g., the proximal end 92) in any of many different ways. In the exemplary embodiments, device 10 can comprise an attachment region 80 configured to secure a portion of band 90 to a part of device 10. Referring to FIGS. 1-2, attachment region 80 can comprise openings 81 and 82, extending through a portion of members 20 and/or 30 (e.g., proximate to a proximal end of device 10). Openings 81 and 82 can be similar to and function substantially similarly to openings 40, 50. Openings 81 and 82 can be positioned apart from each other to form a support portion 83 positioned therebetween. A portion of band 90 (e.g., proximal end 92) can extend through openings 81, 82, and be secured to another portion of band 90 to form a loop in band 90 around portion 83. The loop can be formed in band 90 with an attachment element similar to and functioning substantially similarly to the other attachment elements described herein (e.g., elements 60, 160, 260).

Referring to FIG. 3, attachment region 80 can comprise a portion of band 90 (e.g., proximal end 92) that is secured on one or more sides to a part of device 10 with an attachment element, as described herein for the other embodiments of region 80. Preferably, the attachment region 80 is secured to a portion of members 20 and/or 30, and more preferably, a proximal end of members 20 and/or 30. In some embodiments, band 90 can be integrally formed with a part of device 10 to obviate any need for attachment region 80.

Referring to FIG. 5, attachment region 80 can comprise opening 81 extending through a portion of device 10, such as members 20 and/or 30 (e.g., proximate to a proximal end of device 10). A portion of band 90 (e.g., proximal end 92) can extend through opening 81 and be secured to a portion of device 10, such as member 20 and/or 30, and preferably to side 24 and/or 34, and more preferably, to a portion of side 24 and/or 34 positioned proximate to the proximal end of device 10. This portion of band 90 can be secured to a part of device 10 with an attachment element, as described herein for the other embodiments of region 80.

In some embodiments, device 10 can include, or can be used with, various handling portions integrated into or attached to device 10 and/or band 90 to allow a user to easily grasp device 10 and/or band 90. These handling portions can include various tabs, knobs, dimples, nipples, surface textures and contours (e.g., convex protrusions and concave recessions), ribs, slots, grooves, and the like, spanning some, most or all of various portions of device 10, or other components used with device 10. These handling portions can comprise one or more materials that may improve a user's grip, such as various textured frictional coatings, or resilient materials, such as rubber or foam. Examples of handling portions are provided in U.S. Provisional Patent Application Nos. 61/320,886 and 61/322,708.

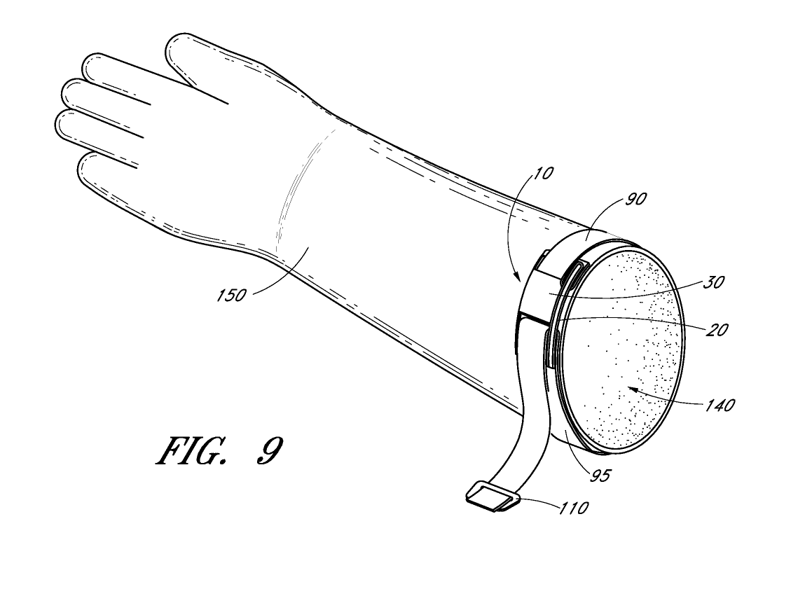

FIG. 7 shows a top plan view of an embodiment of device 10. This embodiment of device 10 can be similar to and function substantially similarly to other embodiments of device 10 described herein. FIG. 7 shows, for exemplary purposes, an embodiment of device 10 integrally formed from a single sheet of material, as described further herein. FIG. 7 also shows, for exemplary purposes, a handling portion 115 positioned at the distal end 32 of member 30 of device 10. Handling portion 115 can comprise any of the embodiments of the handling portions described herein. In the illustrated embodiment, handling portion 115 has a width that is less than the width of the remainder of member 30, and has a tapered edge portion 115a transitioning between the side edges of handling portion 115 and the side edges of the remainder of member 30.

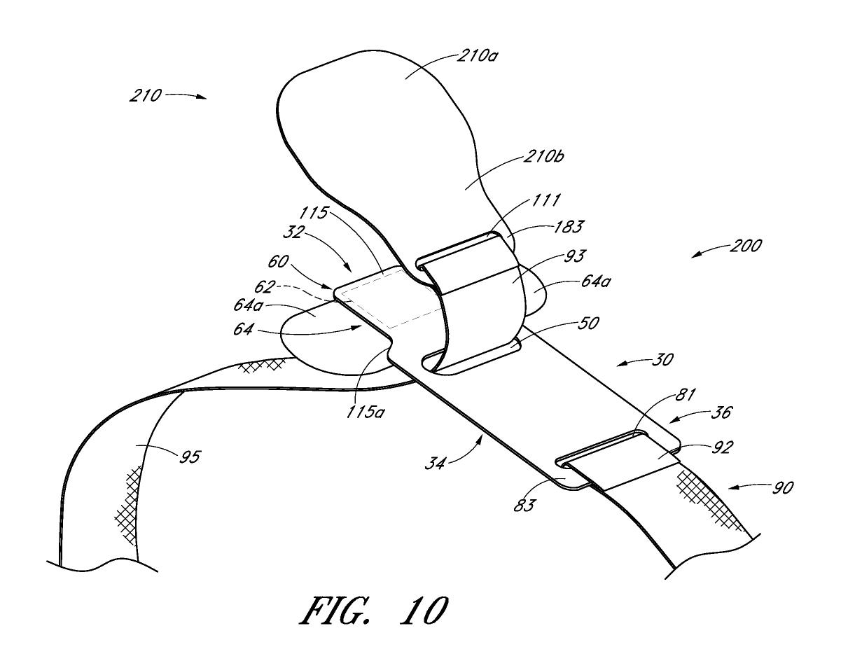

FIGS. 8A and 8B show a front and side view, respectively, of a handling portion 110 that can be used with device 10 and a band 90. Referring to FIGS. 1, 8A and 8B, handling portion 110 can comprise any of many different structures that can be secured to a portion of band 90 (e.g., portion 93). Handling portion 110 can allow a user to more easily grasp and pull band 90, and prevent the free end 93 of band 90 from pulling back through opening 40 and/or 50 after free end 93 has been extended therethrough. Handling portion 110 can also facilitate the use of device 10 and band 90 by a physically challenged user (e.g., an arthritic, geriatric, or other physically-challenged user), and/or allow device 10 to be used more easily with a single hand.

Handling portion 110 can comprise any of many different shapes and materials, such as those described herein for members 20, 30. In the illustrated embodiment, handling portion can comprise an approximately ovular shape. Handling portion 110 can be secured to band 90 in any of many different ways known in the art. In some embodiments, handling portion 110 can comprise two or more pieces that clasp or clamp around a portion of band 90, such as the clasp disclosed in U.S. Provisional Patent Application No. 61/320,886. In the exemplary embodiment, handling portion 110 can be attached to band 90 with an attachment element 120, which is similar to and can function substantially similarly to the other attachment elements described herein. In some embodiments, handling portion 110 can comprise an opening 111 extending therethrough. Opening 111 allows a portion of band 90 to extend from one side of handling portion 110, through opening 111, and be secured on an opposed side of handling portion 110. Handling portion 110 can comprise a support portion 183 positioned between opening 111 and an outer edge of the handling portion 110. A portion of band 90 (e.g., free end 93) can extend through opening 111 and be secured to another portion of band 90 to form a loop in band 90 around support portion 183, and thus function substantially similarly to support portion 83 (FIG. 2).

Handling portion 110 can comprise an additional, optional attachment element that allows handling portion 110 to be secured to a surface (e.g., a portion of band 90, medical barrier 150, or the user's appendage, e.g., object 140; FIG. 9), to prevent band 90 (e.g., free end 93) from tangling or otherwise inconveniencing a user after device 10 has secured a portion of band 90 around a surface.

FIG. 9 shows device 10 in an exemplary embodiment of use with a band 90 and a medical barrier 150. Medical barrier 150 is shown in a glove-shaped configuration, but can comprise any of many different known medical barriers, such as a sheet with one or more openings disposed at its end(s) that can be circumscribed around a user's appendage. Medical barrier 150 can comprise any of the configurations of medical barriers described in U.S. Provisional Patent Application Nos. 61/320,886 and 61/322,708. In the illustrated embodiment, device 10 is shown in Position 2 and securing a portion of band 90 as described further herein. In the illustrated embodiment, at least a portion of the medical barrier 150 is positioned between band 90 and a portion of an object 140 (e.g., a patient's appendage). As such, at least a portion of medical barrier 150 can be held by the band 90 to be at least partially wrapped around a portion of object 140 when the first member 20 and the second member 30 are in Position 2. It will be understood that various portions of band 90 and/or device 10 (e.g., a portion of member 20) can be attached to a portion of medical barrier 150, for example, with one or more additional attachment elements. It will also be understood that various portions of band 90 and/or device 10 can be integrally formed with a portion of medical barrier 150.

FIG. 10 shows a top and right side perspective view of an embodiment of a band-securing device 200 and a band 90. FIG. 11 shows a bottom and left side perspective view of an embodiment of band-securing device 200 and band 90. The elements shown with the same reference numerals in FIGS. 10 and 11 relative to those shown in FIGS. 1-9 are similar to and function substantially similarly to those in FIGS. 1-9, unless otherwise described herein.

Referring to FIGS. 10 and 11, band-securing device 200 can be similar to and can function substantially similarly to those embodiments of device 10 described further herein. One difference is that device 200 is shown for exemplary purposes as comprising the second member 30, without first member 20 formed or engaged therewith. Opening 81 is positioned, for exemplary purposes, proximate to the proximal end 36 of second member 30, with the portion 92 of band 90 attached to end 36.

A handling portion 210 can be used with device 200 and band 90, wherein portion 210 can be similar to and functions substantially similarly to handling portion 110 (FIGS. 1, 8A, 8B, 9). One difference is that handling portion 210 is shown, for exemplary purposes only, with a distal portion 210a at its distal end that is enlarged relative to a proximal portion 210b at its proximal end. Enlarged distal portion 210a allows a user (e.g., a physically-challenged user) to easily grasp handling portion 210 when using device 200 to secure band 90 around an object.

Referring to FIG. 10, another difference is that handling portion 64a is shown, for exemplary purposes only, as extending laterally from both sides of member 30 (e.g., the distal end 32 of member 30). This exemplary embodiment allows a user to grasp handling portion 64a from either side of member 30 to facilitate applying device 10 around an object with band 90.

Referring to FIG. 11, handling portion 210 can be attached to and at least partially cover some, most or all of attachment element 60 (e.g., adhesive 62). In some such embodiments, handling portion 210 can be similar to and function substantially similarly to release layer 64. It will be understood that a portion of band 90 (e.g., free end 93) can be attached to and cover attachment element 60, and thus function substantially similarly to release layer 64, and the embodiments of handling portion 210 described herein. Attaching handling portion 210 to element 60 can prevent handling portion 210 from being lost or separated from member 30 (e.g., when portion 210 is provided as a kit with device 200).

Additionally, when used in conjunction with device 200 and band 90, attaching handling portion 210 to element 60 can secure free end 93 of band 90, preventing band 90 from tangling or getting caught on undesired objects. In such an embodiment, securing free end 93 of band 90 with handling portion 210 can prevent band 90 from moving through opening 50, allowing loop 95 to retain its shape and remain open, allowing a user to easily insert an object (e.g., appendage) through loop 95.

In use, a user wraps a portion of band 90 (e.g. loop 95) at least partially around an appendage (e.g., a user inserts an appendage through an opening formed by loop 95). Next, a user grasps handling portion 210 and removes or separates (e.g., peels) handling portion 210 from member 30, exposing a portion of attachment element 60 (e.g., adhesive layer 62). Next, optionally without releasing the user's grasp on handling portion 210, the user tightens band 90 by pulling handling portion 210 relative to member 200, tightening a portion of band 90 (e.g. loop 95) relative to an object. After band 90 is tightened to a desired tension, the user pulls handling portion 210 and a portion of band 90 (e.g., free end 93) towards the remaining portion of band 90 (e.g., a portion of loop 95), such that the exposed portion of attachment element 60 (e.g. exposed adhesive layer 62) moves towards the remaining portion of the band, attaching member 30 to said remaining portion of the band 90. In a preferred embodiment, these steps can be performed using a single hand.

It will be understood that device 200 is shown with a single attachment element 60 for exemplary purposes, and device 200 can comprise one or more additional attachment elements similar to and functioning substantially similarly to attachment element 164 (FIGS. 4A-4B). It will also be understood that handling portion 210 can be used in conjunction with a band 90 and the previously described device 10 shown in FIGS. 1 and 9, and the device 300 described below.

FIG. 12 shows a top and left side perspective view of an embodiment of a band-securing device 300 and a band 90. FIG. 13 shows a bottom and left side perspective view of an embodiment of band-securing device 300 and band 90. The elements shown with the same reference numerals in FIGS. 12 and 13 relative to those shown in FIGS. 1-11 are similar to and function substantially similarly to those in FIGS. 1-11, unless otherwise described herein.

Referring to FIGS. 12 and 13, band-securing device 300 can be similar to and can function substantially similarly to those embodiments of device 200 described further herein. One difference is that device 300 is shown for exemplary purposes as comprising a guide portion 335 comprising a guide 336. Guide portion 335 and guide 336 can be substantially similar to and function substantially similar to guide portion 35 and guide 36 (FIG. 6A). Guide 336 is shown positioned, for exemplary purposes, along member 30 distally relative to opening 50 and first attachment element 60. The illustrated guide 336 is configured as an opening (e.g. a slot) that can extend through member 30, and span some or most of the width of member 30. In some embodiments, member 30 can comprise a substantially flat portion, with guide 336 and/or opening 50 extending through the substantially flat portion of member 30. It will be understood that device 300 can be used with one or more handling portions (e.g., handling portion 210; FIGS. 10-11; handling portion 110; FIGS. 1, 8A, 8B, and 9; handling portion 115; FIGS. 7, 10-11), although these handling portions are not shown in FIGS. 12 and 13.

In some embodiments, member 30 can flex about an axis 500 extending across the width of member 30, and in some embodiments, spanning opening 50. During use, a user can grasp a portion of band 90 (e.g., free end 93) and/or an optional handling portion (FIGS. 1, 8A, 8B, 9-11), and move (e.g., pull) the portion of band 90 away from the object around which device 300 is securing a portion of band 90. This movement of the band can move guide portion 335 and the distal end 32 of member 30 away from said object. This movement can cause member 30 to flex about axis 500, moving attachment element 60 (e.g., exposed adhesive 62) away from the object to which the attachment element 60 is being secured (e.g. a portion of band 90, such as loop 95). This makes it easier for a user to prevent the attachment element 60 from inadvertently attaching to an undesired object, as described further herein. Next, optionally without releasing the user's grasp on the band 90 (and/or the handling portion), the user tightens band 90 by pulling the band 90 (and/or the handling portion) relative to member 30, tightening a portion of band 90 (e.g. loop 95) relative to an object. After band 90 is tightened to a desired tension, the user pulls the portion of band 90 (e.g., free end 93) towards the remaining portion of band 90 (e.g., a portion of loop 95), moving guide 335, the distal end 32 of member 30 and the exposed portion of attachment element 60 (e.g. exposed adhesive layer 62) towards the remaining portion of the band 90, such that member 30 attaches to said remaining portion of the band 90. In some embodiments, the user can (1) pull the portion of band 90 (e.g., free end 93) away from the remaining portion of band 90 (e.g., a portion of loop 95), such that guide 335, the distal end 32 of member 30, and the portion of attachment element 60 (e.g., adhesive layer 62) move away from the remaining portion of the band 90, (2) peel attachment element 60 from the object to which it is attached, and (3) unsecure (e.g., remove) member 30 from said remaining portion of the band 90. In a preferred embodiment, these steps can be performed using a single hand.

It will be understood that device 300 is shown with a single attachment element 60 for exemplary purposes, and device 300 can comprise one or more additional attachment elements similar to and functioning substantially similarly to attachment element 164 (FIGS. 4A-4B).

Although certain preferred embodiments and examples have been discussed herein, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the present disclosure, including the appended claims.

What is claimed is:

1. A band-securing device comprising:
a first member having a first opening extending therethrough;
a second member having a second opening extending therethrough, the second member being formed with or engaged with respect to the first member such that the first and second members can flex or pivot relative to each other; and
a first attachment element positioned on the second member distally relative to the second opening, the first attachment element configured to be secured to any of multiple locations along a length of a band;
wherein the first and second members can be flexed or pivoted relative to each other between a first relative position in which a portion of the first member is spaced from the second member, and a second relative position in which said portion of the first member is substantially adjacent to the second member.

2. The band-securing device of claim 1, wherein at least a portion of the first attachment element extends distally relative to a distal end of the first member when the first and second members are in said second relative position.

3. The band-securing device of claim 1, in combination with a band, wherein a portion of the band is secured to part of the closure device.

4. The band-securing device of claim 3, wherein the band is elastic.

5. The band-securing device of claim 3, further comprising a loop in the band into which an object can be inserted, the loop extending from the portion of the band secured to part of the closure device to the second opening in the second member.

6. The band-securing device of claim 1, wherein the first attachment element is configured to secure the first member to the second member when the first and second members are in said second relative position.

7. The band-securing device of claim 1, wherein the first member and the second member are integrally formed together.

8. The band-securing device of claim 1, wherein first relative position of the first and second members represents a quiescent state of the band-securing device.

9. The band-securing device of claim 1, wherein the first member and the second member are formed with or engaged with respect to each other at their proximal ends.

10. The band-securing device of claim 1, wherein the first opening and the second opening are substantially aligned relative to each other when the first member and the second member are in the second relative position.

11. The band-securing device of claim 1, further comprising a second attachment element configured to secure a portion of a band to part of the band-securing device.

12. The band-securing device of claim 11, wherein the second attachment element comprises one or more openings extending through either or both of the first member and the second member.

13. The band-securing device of claim 12, wherein the second attachment element comprises an adhesive layer.

14. The band-securing device of claim 1, further comprising a second attachment element configured to secure the first member to the second member when the first member and the second member are in the second relative position.

15. The band-securing device of claim 1, further comprising a second attachment element positioned distally on the second member relative to the first attachment element, the second attachment element configured to be secured to any of multiple locations along a length of a band.

16. The band-securing device of claim 3, in combination with a medical barrier configured to be held by the band in a partially wrapped position around a portion of a patient's appendage when the first member and the second member are in the second relative position.

17. The band-securing device of claim 16, wherein at least one of the band and the band-securing device is attached to the medical barrier.

18. The band-securing device of claim 1, wherein the first attachment element is configured to secure to a portion of a band that extends under a portion of the first member.

19. The band-securing device of claim 1, further comprising a third opening extending through the first member, wherein the first attachment element extends through the third opening to attach to a portion of a band.

20. The band securing device of claim 3, wherein a handling portion is secured to a free end of the band or the first attachment element.

21. A band-securing device comprising:
a first member having a first opening extending therethrough;
a second member having a second opening extending therethrough, the second member being formed with or engaged with respect to the first member such that the first and second members can flex or pivot relative to each other;
an attachment element positioned on the second member distally relative to the second opening, the attachment element configured to be secured to any of multiple locations along a length of a band; and
wherein the first and second members can be flexed or pivoted relative to each other between a first relative position in which a portion of the first member is spaced from the second member, and a second relative position in which said portion of the first member is substantially adjacent to the second member, the first and second members being in the first relative position in a quiescent state of the closure device, the first and second members being in the second relative position when subjected to a force urging said members together.

22. The band-securing device of claim 21, wherein at least a portion of the attachment element extends distally from a distal end of the first member when the first and second members are in said second relative position.

23. A band-securing device comprising:
a first member having a first opening extending therethrough;
a second member having a second opening extending therethrough, the second member being formed with or engaged with respect to the first member such that the first and second members can flex or pivot relative to each other;
a first attachment element positioned on the second member distally relative to the second opening; and
a band comprising a first segment configured to attach to the first attachment element and a second segment connected to another part of the band-securing device;
wherein the first and second members can be flexed or pivoted relative to each other between a first relative position in which a portion of the first member is spaced from the second member, and a second relative position in which said portion of the first member is substantially adjacent to the second member.

24. The band-securing device of claim 23, wherein at least a portion of the first attachment element extends distally relative to the distal end of the first member when the first and second members are in said second relative position.

25. The band-securing device of claim 23, wherein a portion of the second segment of the band is formed integrally with said another part of the band-securing device.

26. The band-securing device of claim 23, wherein one or more openings extend through either or both of the first member and the second member, the second segment of the band being connected to said another part of the band-securing device by extending through the one or more openings.

27. The band-securing device of claim 23, further comprising an adhesive layer connecting the second segment to said another part of the band-securing device.

28. The band-securing device of claim 23, wherein the second segment of the band is stitched to said another part of the band-securing device.

29. A band-securing device comprising:
a member having a first opening extending therethrough;
a band extending through the first opening, wherein a portion of the band is secured to a part of the member;
an attachment element positioned on the member distally relative to the first opening, the attachment element configured to be secured to any of multiple locations along a length of the band; and
a handling portion secured to a free end of the band, the handling portion configured to prevent the free end of the band from being pulled through the first opening.

30. The band-securing device of claim 29, wherein the handling portion is secured to the attachment element.

31. The band-securing device of claim 29, further comprising a guide on the member, the guide positioned distally relative to the attachment element, the guide configured to receive the band.

32. The band securing device of claim 31, wherein the guide comprises a second opening extending through the member.

33. A band-securing device comprising:
a member having a first opening extending therethrough;
an attachment element positioned on the member distally relative to the first opening, the attachment element configured to be secured to any of multiple locations along a length of a band; and
a handling portion configured to be secured to a free end of a band, wherein the handling portion is secured to the attachment element.

34. The band-securing device of claim 33, in combination with a band, wherein a portion of the band is secured to part of the band-securing device.

35. The band-securing device of claim 33, further comprising a guide for a band on the member, the guide positioned distally relative to the attachment element.

36. The band-securing device of claim 35, wherein the member comprises a substantially flat portion, the first opening extending through the substantially flat portion, the guide comprising a second opening extending through the substantially flat portion.

37. A band-securing device comprising:
a member comprising a substantially flat portion, the member having a first opening extending through said substantially flat portion;
an attachment element positioned on the member distally relative to the first opening, the attachment element configured to be secured to any of multiple locations along a length of a band; and
a guide for a band on the member, the guide positioned distally relative to the attachment element, the guide comprising a second opening extending through the substantially flat portion of the member.
